(19) United States
(12) Patent Application Publication
(10) Pub. No.: US 2013/0199692 A1
(43) Pub. Date: Aug. 8, 2013

(54) Surface Functionalization of Polyester

(71) Applicants: Carlos D. Gutierrez, Spartanburg, SC (US); Ali Evren Ozcam, Woodbury, MN (US); Richard John Spontak, Raleigh, NC (US); Jan Genzer, Raleigh, NC (US)

(72) Inventors: Carlos D. Gutierrez, Spartanburg, SC (US); Ali Evren Ozcam, Woodbury, MN (US); Richard John Spontak, Raleigh, NC (US); Jan Genzer, Raleigh, NC (US)

(73) Assignees: NORTH CAROLINA STATE UNIVERSITY, Raleigh, NC (US); UNITED RESOURCE RECOVERY CORPORATION, Spartanburg, SC (US)

(21) Appl. No.: 13/813,245

(22) PCT Filed: Aug. 1, 2011
(86) PCT No.: PCT/US2011/046118

§ 371 Date: Apr. 5, 2013

Related U.S. Application Data
(60) Provisional application No. 61/369,334, filed on Jul. 30, 2010.

(51) Int. Cl. B05D 7/24

(52) U.S. Cl. CPC B05D 7/24
USPC 156/60; 427/430.1; 427/393.5; 427/344

(57) ABSTRACT

Methods for surface treatment of polyester substrates are described. Treatment methods include adherence of a polymer layer on a surface of the polyester so as to increase the hydrophilic properties of the surface. Polymers can be polyelectrolytes that are adsorbed at the surface or polymer brushes that are polymerized at the surface. Further surface functionalization can include the adherence of inorganic nanoparticles to the surface. The polyester substrates can be recycled polyester such as recycled polyethylene terephthalate that has been subjected to a partial saponification reaction during the recycling process.

### CROSS REFERENCE TO RELATED APPLICATION

This application claims filing benefit of U.S. Provisional Patent Application Ser. No. 61/369,334, having a filing date of Jul. 30, 2010, which is incorporated herein by reference.

### BACKGROUND

Utilization of polymeric materials in daily life continues to increase steadily and is expected to reach 365 million tons in 2015 at an annual growth rate of 8.1%. The packaging industry is responsible for the largest share of polymer consumption, but the polymers used in this fashion are commonly discarded after a single use, which promotes growing landfill concerns. Environmental considerations coupled with the limited supply and increasing price of oil, necessitate polymer recycling on a global basis.

Polyethylene terephthalate (PET) is one of the most important thermoplastics in ubiquitous packaging use today due to its mechanical properties, clarity, and solvent resistance. Efficient and high-throughput chemical recycling processes have been developed that remove only the outer layer of PET flakes without degrading the entire polymer. See, for example, U.S. Pat. Nos. 5,958,987; 6,197,838; 7,070,624; 6,147,129; 7,097,044; 7,098,299; and 7,338,981, all of which are incorporated herein by reference. These multi-step processes remove impurities from waste PET, resulting in food-grade recycled PET (rPET).

While the above describes improvement in the art, further improvement may be made. For instance, polymer recycling is routinely accompanied by nontrivial deterioration of physical properties, which is why recycled polymers are frequently used as only fillers or other low-value materials. Accordingly, it would add value to rPET by endowing it with properties of technological interest, for instance via surface modification. Such materials could be used, e.g., in forming rPET composites that exhibit desirable characteristics.

For example, previous studies have shown that dispersing nanometer-sized clay materials at relatively low loading levels in polymer matrices can form polymer composites exhibiting flame retardancy as well as desirable mechanical and barrier properties without adversely affecting polymer transparency. To maximize this benefit, the individual layers of clay stacks should be exfoliated and uniformly dispersed throughout the polymer matrix. Unfortunately, the large size and inherently hydrophobic nature of polymer molecules such as polyester impedes the dispersion of clay. Earlier commercial efforts, such as pioneering work by Toyota, have relied on the organic modification of natural clays with quaternary alkyl ammonium salts to assist clay dispersion in polymer matrices. However, the low thermal stability of organically-modified clays at the processing temperatures of polyester, and particularly of PET, promotes accelerated polymer degradation, which consequently prohibits the use of such nanocomposites in “clean” applications, such as food packaging.

Methods for forming polyester/particle nanocomposites in which nano-sized particulates such as clay may be well dispersed throughout a polymer matrix would be of great benefit.

### SUMMARY

According to one embodiment, disclosed is a method for recycling polyester. The method can include forming a slurry comprising polyester and an alkaline compound and saponifying only a portion of the polyester according to a saponification reaction between the polyester and the alkaline compound. In addition, the method can include forming a polymeric layer on the surface of the polyester that remains following the saponification reaction. Beneficially, the formation of the polymeric layer can increase the hydrophilicity of the polyester surface.

The polymeric layer may be formed via adsorption of a polyelectrolyte at the surface or may be formed by polymerizing a monomer at the surface.

A method may also include adhering an inorganic species to the polymeric layer. For instance, a natural clay or a metal nanoparticle may be adhered to the polymeric layer that has been formed on the polyester substrate. In one embodiment, the recycled polyester may be further processed, for instance melt processed, to form a new product from the recycled polyester nanocomposite.

According to another embodiment, disclosed is a method for functionalizing the surface of a polyester substrate. The method can include bonding an amino silane coupling agent to the surface of the polyester substrate and then hydrolyzing the silane groups of the coupling agent to form silanol groups. Following, an polymerization initiator, e.g., an atom transfer radical polymerization (ATRP) initiator, can be bonded to the substrate via a reaction between the initiator and the silanol groups. A monomer may then be polymerized at the substrate surface according to a polymerization process such as ATRP to form a polymer brush at the surface of the polyester substrate.

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying figures in which:

FIG. 1 is a schematic diagram showing rPET and clay platelets in an aqueous mixture.

FIG. 2 is a schematic diagram illustrating a process of forming a polymer/clay nanocomposite formed through utilization of a polyelectrolyte layer.

FIG. 3 is a schematic diagram illustrating a process of forming a polymer brush on a PET surface.

FIGS. 4A and 4B compare the surface atomic concentration of rPET and rPET following adsorption of a natural clay to the surface of the rPET with no intervening hydrophilic polymer between the two.

FIGS. 5A and 5B compare the water contact angle for rPET substrates following adsorption of a polyelectrolyte layer (FIG. 5A) and following further adsorption of a clay to the polyelectrolyte layer (FIG. 5B).

FIGS. 5C and 5D illustrate the thickness of the clay layer (FIG. 5C) and the polyelectrolyte layer (FIG. 5D) on coated substrates.

FIGS. 6A and 6B illustrate the surface atomic concentration of an rPET substrate following adsorption of a polyelectrolyte layer (FIG. 6A) and following further adsorption of a clay to the polyelectrolyte layer (FIG. 6B).

FIG. 7A illustrates the change in viscosity with shear rate for rPET and rPET following extrusion.

FIG. 7B illustrates the change in viscosity with shear rate for rPET and coated rPET prior to extrusion.

FIG. 7C illustrates the change in viscosity with shear rate for rPET and coated rPET following extrusion.

FIGS. 8A and 8B are images of an electrospun PET fiber prior to (FIG. 8A) and following (FIG. 8B) growth of a polymer brush on the fiber.

FIG. 9A presents FTIR spectra of as-spun PET (a), PET-SiOH (b), and PET-PNIPAAm brush (c) microfibers.

FIG. 9B is an expanded section of FIG. 9A.

FIG. 9C is another expanded section of FIG. 9A.

FIGS. 10A and 10B illustrate the X-ray photoelectron spectroscopy (XPS) measurements of an electrospun PET fiber (FIG. 10A) and a PET fiber following growth of a polymer brush on the fiber (FIG. 10B). The insets of FIGS. 10A and 10B are the high-resolution C₁ₛ spectra corresponding to each XPS.

FIG. 11 illustrates the thermoresponsive nature of a poly(N-isopropyl acrylamide) brush on a PET substrate.

FIGS. 12A and 12B demonstrate eletrospun fibers functionalized with a thermoresponsive polymer brush following attachment of gold nanoparticles at 25° C. (FIG. 12A) and at 60° C. (FIG. 12B).

### DETAILED DESCRIPTION

In general, disclosed herein are methods for surface treatment of recycled polyester that has been subjected to a partial saponification during the recycling process. Through the targeted use of polymers and surface polymerization methods, the surface of the recycled polyester can be made hydrophilic, which permits covalent attachment of various inorganic species, such as natural nanoclay and nanoparticles, so as to functionalize the polyester for a wide variety of high-end applications. For instance, in one embodiment the surface functionalized recycled polyester can be in the form of polyester chips that can be reprocessed to form new products, such as packages. Upon formation of the new product, the surface functionalization on the feed chips can be distributed homogeneously throughout the newly formed composite, providing desirable characteristics to the composite.

The surface functionalization described herein can be carried out on a recycled polyester substrate. As used herein, the term polyester generally refers to an esterification or reaction product between a polybasic organic acid and a polyol. It is believed that any known polyester or copolyester may be recycled according to a partial saponification reaction and surface functionalized as disclosed herein. The present disclosure is particularly directed to a class of polyesters referred to herein as polyol polyterephthalates, in which terephthalic acid serves as the polybasic organic acid, and particularly to PET, but it should be understood that the disclosure is not in any way limited to PET.

The rPET can be derived from waste PET such as bottles and containers. During processing, the waste PET can be partially saponified in a recycling process. Methods for recycling polyesters through partial saponification have been described, for instance in U.S. Pat. Nos. 5,958,987; 6,197,838; 7,070,624; 6,147,129; 7,097,044; 7,098,299; and 7,338,981, previously incorporated herein by reference. According to a typical recycle process, the feed polyester can be pre-processed in one or more unit operations. Pre-processing operations can include chopping or grinding, for instance in a sizing operation, as well as one or more separation processes (e.g., elutriation, sink/float, high speed fluidization, screening operations, metal removal, color sorting, etc.) that can be used to separate contaminants from the polyester. Separation operations can be carried out either prior to or following the saponification reaction of the recycling process. The preferred location of a particular separation process during a recycling process can generally depend upon the nature of contaminant to be removed. For instance, in the case of certain embedded or adhered materials, a separation operation may be carried out either during or following the partial saponification step.

Following preparation and any pre-reaction operations on the feed containing the polyester, the polyester flake can be subjected to a reaction that includes partial saponification of the polyester. A reaction process can include formation of a slurry including the polyester flake and an alkaline compound. The alkaline compound can be, in one preferred embodiment, sodium hydroxide, known commonly as caustic soda. Other metal hydroxides and alkalines can optionally be used in addition to or instead of sodium hydroxide. For example, suitable compounds can include calcium hydroxide, magnesium hydroxide, potassium hydroxide, lithium hydroxide or mixtures thereof. When used in solution, the metal hydroxide can be combined with water prior to mixing with the materials containing the polyester. For instance, in one embodiment, the metal hydroxide can be mixed with water in about a 1 to 1 ratio.

The amount of the alkaline composition added to the materials containing the polyester will generally depend upon the type and amount of impurities and contaminants present within the materials. Generally, the alkaline composition will be added only in an amount sufficient to separate the impurities from the polyester, so as to minimize the saponification of the polyester. In most applications, the alkaline composition can be added to the materials in a stoichiometric amount sufficient to react with up to about 50% of the polyester. In one embodiment, the alkaline composition is added in an amount sufficient to react with less than about 10% of the polyester, for instance about 3% of the polyester.

During the reaction, chemical degradation of PET in the caustic solution is restricted to only the outermost surface of the flakes. This benefit allows select removal of a thin layer of the polyester along with other impurities from flakes during recycling, instead of depolymerizing entire flakes to recover monomer as has been utilized in other recycling processes. This process can employ multiple separation and quality-control steps to ensure food-grade recycled polyester and can reap the benefit of high throughput and energy savings while conserving important natural resources, such as water.

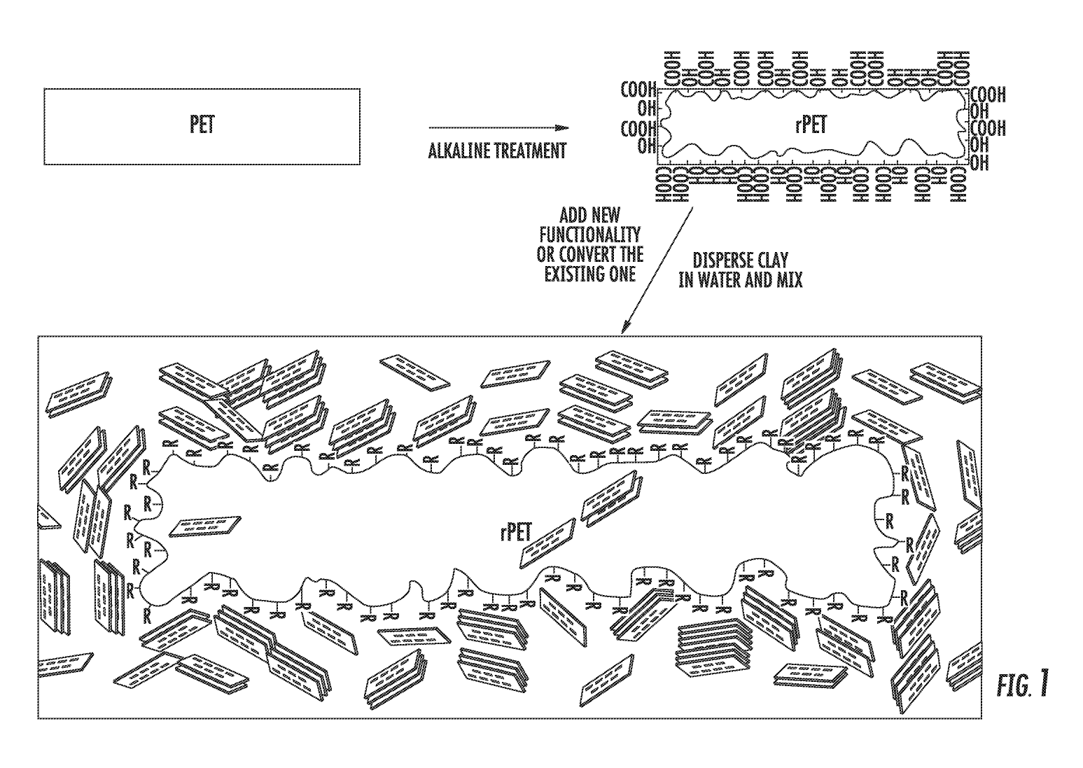

Following the partial saponification of the polyester, both chemical functionalities and roughness can be created on the surface of the flakes. This alteration in the polyester due to the saponification reaction can provide a platform onto which additional functionalization can be formed. More specifically, the surface of the recycled polyester may include increased roughness as well as carboxyl functionality as illustrated in FIG. 1, and via that functionality may be modified for example either through the water-mediated adsorption of a cationic polyelectrolyte or the surface growth of a polymer brush, both of which may then serve to enhance attachment of nanoparticles such as natural clay platelets as well as water-dispersed nanoparticles to the surface as schematically illustrated in FIG. 1. The addition of a polymer to the surface of the polyester can increase the hydrophilicity and area of the polyester and thus form a “sticky” polyester surface to which a hydrophilic inorganic species may be attached. In one embodiment, the surface-modified polyester may be subsequently melt-processed to form a nanocomposite including the nanomaterials and the nanomaterials may be well dispersed throughout the polymer matrix.

In one preferred embodiment, the surface functionalization of the recycled polyester can be added as a unit operation into an existing recycling process line with little cost.

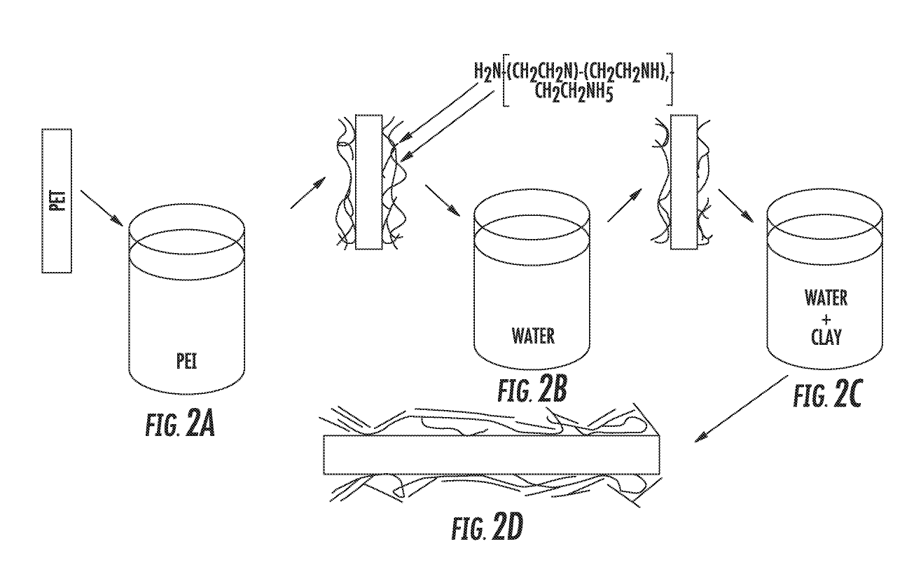

According to one embodiment, schematically illustrated in FIG. 2, a polyelectrolyte can be deposited on the surface of the recycled polyester in the form of a molecularly-thin monolayer. The polyelectrolyte may be a cationic polyelectrolyte, which can bind to the negatively charged surface of the polyester that is formed during the partial saponification of the polyester. Some suitable examples of polyelectrolytes having a net positive charge include, but are not limited to, polylysine (commercially available from Sigma-Aldrich Chemical Co., Inc. of St. Louis, Mo.), polyethylenimine; epichlorohydrin-functionalized polyamines and/or polyamidoamines, such as poly(dimethylamine-co-epichlorohydrin); polydiallyldimethyl-ammonium chloride; cationic cellulose derivatives, such as cellulose copolymers or cellulose derivatives grafted with a quaternary ammonium water-soluble monomer; and so forth. However, one of ordinary skill in the art will appreciate that it is possible to provide a number of different polymers and copolymers that could have a cationic portion as well as, for example, a nonionic and hydrophilic portion, that can adhere to the functionalized surface of the partially saponified polyester and increase the hydrophilicity of the flake.

While the molecular weight of the polyelectrolyte can vary significantly, the molecular weight of the polyelectrolyte is typically within a range of from about 20,000 to about 2,000,000, for instance from about 200,000 to about 400,000.

A variety of analytical techniques may be used for deposition of the cationic polymer. In one preferred embodiment illustrated in FIG. 2, a cationic polyelectrolyte may be adsorbed to the functionalized surface of the partially saponified polyester flakes through electrostatic attraction in an aqueous deposition process. Moreover, the aqueous deposition process may be a unit operation in a recycle process, so as to provide a value added recycled polyester product.

When adhering a polyelectrolyte layer to recycled polyester, molecular weight, ionic strength, polymer concentration and pH can be contributory factors in the molecular adhesion of the polymer to the polyester substrate and, in turn, an inorganic species to the polymer layer on the substrate. With regard to ionic strength, a salt such as NaCl, NaNO₃, KCl, Na₂SO₄, KNO₃ or other salt, can be combined with water to create a solution having an ionic strength ranging from about 0.01 molar (moles of salt/liter of water) to about 0.2 molar. In addition, an acid or base may be added, as needed, in order to regulate the pH of the solution as desired. In general, the pH of the solution will provide a moderate to high pH such as a pH from about 7 to about 10. Examples of acids that can be used include, but are not limited to, HCl, H₂SO₄, HNO₃, H₃PO₄ or others. Examples of bases that can be used to regulate the pH of the solution include NaOH, KOH, NH₄OH or others.

After preparing the solution with the desired concentration of salt and any desired pH adjustment, the polyelectrolyte component can be added to the solution, as shown at (a) in FIG. 2. The partially saponified polyester can then be coated with the solution, for instance in a dip-coating process, a spin-coating process, or the like. Following removal from the solution, the surface treated polyester flakes can be washed to remove excess polyelectrolyte and salt, as shown at (b) in FIG. 2, and can be dried in advance of additional functionalization, or alternatively can proceed directly to another unit operation without drying. Further functionalization can include, e.g., functionalization with clay nanoparticles according to an aqueous solution process, as shown at (c) and (d) in FIG. 2.

According to one preferred embodiment, the polyelectrolyte layer is a monolayer, though this is not a requirement of the disclosure. For instance, an adsorbed polyelectrolyte layer may be from about 5 nanometers to about 20 nanometers in thickness, although other variations can be utilized.

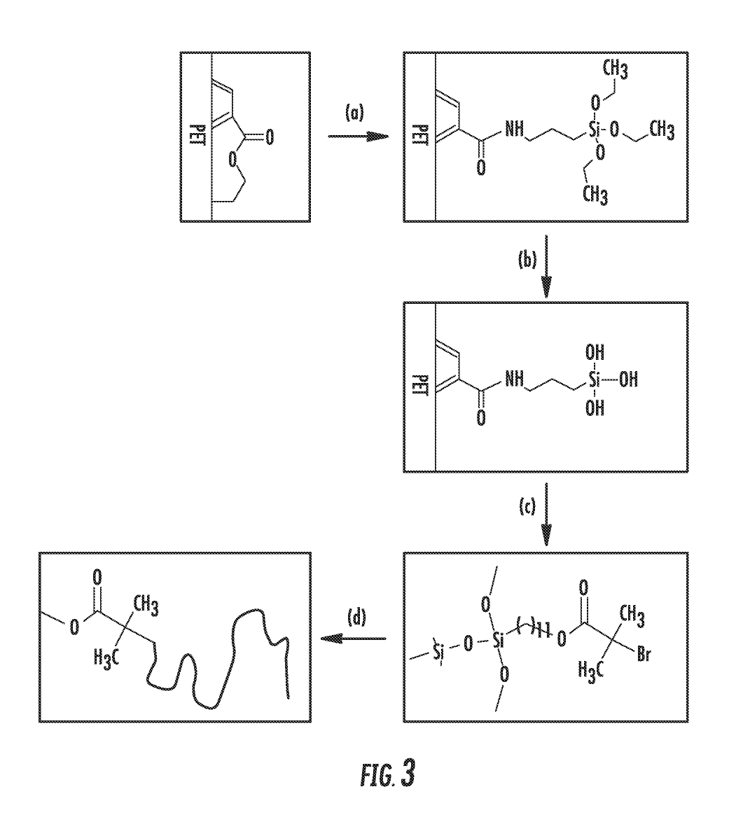

According to another embodiment, schematically illustrated in FIG. 3, a hydrophilic polymer brush can be grown on the surface of a polyester substrate, which can increase the hydrophilicity of the surface and provide a platform for addition of inorganic species to the polyester substrate. Moreover, it has been found that while this particular functionalization method works exceedingly well on a polyester substrate that has been partially saponified according to a recycling process, it may also be carried out on a polyester substrate that has not been partially saponified prior to the formation of the polymer brush. For instance, a polymer brush may be formed on a melt processed or solution processed polyester. For example, a polymer brush may be formed on a polyester following electrospinning of the polyester to form microfibers, with subsequent formation of a polymer brush on the microfibers.

Electrospinning is a fabrication technique capable of generating solid polymer fibers that range from tens of nanometers to several micrometers in diameter. Such nano/microfibers are of fundamental and technological interest due to their high surface-to-volume ratio. During wet electrospinning, a polymer solution of sufficiently high viscosity and conductivity is subjected to an electric field. When the electrostatic forces overcome surface tension, a charged jet is emitted from the tip of the nozzle that undergoes a whipping action and forming a Taylor cone wherein the solvent evaporates. The formed fiber is subsequently collected as a dry, randomly oriented fiber mat on a grounded collector plate. This process strategy is appealing due to the simple setup required and the ability to tailor fiber characteristics with relative ease.

Although the morphology of electrospun nano/microfibers is often desirable, they tend to lack the functionality that is sought in contemporary applications. One way to overcome this deficiency is through surface functionalization as described herein, in which a hydrophilic polymer brush may be formed on the electrospun fibers. The polymer brush may then be further functionalized, for instance with an inorganic species.

According to this embodiment, the surface of the polyester substrate may be functionalized via amidation to provide a functional group for attachment of a polymerization initiator to the surface of the substrate as shown at FIG. 3(a). More specifically, the surface may be functionalized with an amino silane coupling agent. An amino silane coupling agent can be of the formula R¹—Si—(R²)₃, wherein R¹ is an amino group such as NH₂; an aminoalkyl of from about 1 to about 10 carbon atoms, for instance from about 2 to about 5 carbon atoms, such as aminomethyl, aminoethyl, aminopropyl, aminobutyl, and so forth; an alkene of from about 2 to about 10 carbon atoms, for instance from about 2 to about 5 carbon atoms, such as ethylene, propylene, butylene, and so forth; and an alkyne of from about 2 to about 10 carbon atoms, for instance from about 2 to about 5 carbon atoms, such as ethyne, propyne, butyne and so forth; and wherein R² is an alkoxy group of from about 1 to about 10 carbon atoms, preferably from about 2 to about 5 carbon atoms, such as methoxy, ethoxy, propoxy, and so forth.

Some representative examples of amino silane coupling agents that may be used include aminopropyl triethoxy silane, aminoethyl triethoxy silane, aminopropyl trimethoxy silane, aminoethyl trimethoxy silane, ethylene trimethoxy silane, ethylene triethoxy silane, ethyne trimethoxy silane, ethyne triethoxy silane, aminoethylaminopropyltrimethoxy silane, 3-aminopropyl triethoxy silane, 3-aminopropyl trimethoxy silane, 3-aminopropyl methyl dimethoxysilane or 3-aminopropyl methyl diethoxy silane, N-(2-aminoethyl)-3-aminopropyl trimethoxy silane, N-methyl-3-aminopropyl trimethoxy silane, N-phenyl-3-aminopropyl trimethoxy silane, bis(3-aminopropyl) tetramethoxy silane, bis(3-aminopropyl) tetraethoxy disiloxane, and combinations thereof.

It may be preferred in one embodiment to utilize a bulky amino silane coupling agent, such as aminopropyl triethoxy silane (APTES) as the bulky triethoxysilane group on APTES hinders diffusion, changes its chemical nature upon amidation and creates a barrier by restricting the diffusion of other APTES molecules. Use of a bulky amino silane coupling agent may be beneficial when considering polymer brush formation on a relatively small substrate, such as an electrospun fiber.

The amino silane coupling agent can be attached to polyester substrate according to any suitable methodology, for instance via an aminolysis reaction. For instance, an amino silane coupling agent, such as aminopropyl triethoxy silane (APTES) may be deposited on partially saponified polyester flakes by exposing the flakes to a solution of the coupling agent, for instance a 1% (v/v) APTES/anhydrous toluene solution. Following deposition, the silane groups of the coupling agent may be hydrolyzed to form silanol groups as shown at FIG. 3(b), which may be utilized for attachment of a suitable polymerization initiator (FIG. 3(c)). For instance, the functionalized substrate surface may be exposed to acidic water at a pH of from about 4.5 to about 5, which promotes hydrolysis of the ethoxysilane groups to silanol groups.

A polymerization initiator may be bonded to the silanol groups and utilized in formation of a polymer brush according to any suitable polymerization method. In one embodiment, the polymerization method may be atom transfer radical polymerization (ATRP) as is generally known, though the polymerization method is not limited to ATRP and other methods, such as radical polymerization may alternatively be utilized. Polymerization initiators can generally include organic halides as are generally known in the art, such as alkyl halides, and in one particular embodiment, an alkyl bromide. The preferred polymerization initiator can generally depend upon the polymer to be formed at the surface and the specific polymerization method to be used. In general, an initiator can be chosen that is similar in organic framework to the propagating radical. For instance, when polymerizing N-isopropyl acrylamide (NIPAAm) to form poly(N-isopropyl acrylamide) (PNIPAAm) a representative initiator such as [11-(2-bromo-2-methyl)propionyloxy]undecyltrichlorosilane (BMPUS) may be utilized.

An ATRP can be carried out (FIG. 3(d)) according to standard process, through utilization of a transition metal catalyst in the presence of the initiator and the monomer at suitable reaction conditions. In one preferred embodiment, the ATRP can take place in an aqueous environment, and can be a unit operation in a polyester recycling process, but this is not a requirement of the process, and other solvents as are generally known such as toluene, xylene, and the like may alternatively be utilized.

There is no particular limit to the hydrophilic polymers that may be formed as a polymer brush on the surface of the polyester substrate. Monomers used include typical ATRP monomers that include substituents that can stabilize the propagating radicals including, without limitation, styrenes, methacrylates, methacrylamides, and acrylonitriles. Polymers can include, without limitation, PNIPAAm, poly(hydroxyethyl)methacrylate) (PHEMA), poly((2-dimethyleamino)ethyl methacrylate) (PDMAEMA) and quaternized PDMAEMA, and so forth. In one embodiment, a polymer can be selected for formation of a polymer brush that exhibits a response to environmental stimulus. For example, an electroactive or thermoresponsive polymer may be polymerized on the surface of a polyester substrate. By way of example, a thermoresponsive polymer such as PNIPAAm may be utilized to form a polymer brush on a polyester substrate, A ‘smart’ material such as a temperature sensitive polyester-based functionalized material may be suitable candidates for diverse technologies as responsive filters, scaffolds, delivery vehicles, and sensors.

A polyester substrate that has been functionalized with a polymer so as to become more hydrophilic may be further functionalized with an inorganic species. For instance, following functionalization of rPET flakes with either a polyelectrolyte or a polymer brush, the composite materials may be further functionalized with nano-sized clay particulates. As previously described, attempts to form a polyester/clay nanocomposite in the past have met with difficulties due to the hydrophobic nature of the substrate and hydrophilic nature of the natural clay. Attempts to introduce organically modified clay composites to the matrix has met with little success due to the high temperature processing necessary to produce polymer composites for clean technologies such as food packaging.

According to the present disclosure, however, due to the surface functionalization of the polyester, natural, non-modified clay can be adhered to the substrate surface in a relatively simple, inexpensive process. As utilized herein, the term “clay” generally refers to a material that includes a hydrated silicate of an element such as aluminum, iron, magnesium, potassium, hydrated alumina, iron oxide, and so forth. Clays are phyllosilicates, characterized by two-dimensional sheets of corner-sharing tetrahedra and octahedra, for instance SiO₄ and AlO₄ tetrahedra and octahedra. Clays generally are formed in either a 1:1 or a 2:1 layer structure. A 1:1 clay includes one tetrahedral sheet and one octahedral sheet, examples of which include kaolinite and serpentinite. A 2:1 clay includes an octahedral sheet sandwiched between two tetrahedral sheets, examples of which include montmorillonite, illite, smectite, attapulgite, and chlorite (although chlorite has an external octahedral sheet often referred to as “brucite”).

Examples of natural clays as may be utilized in forming a nanocomposite, include, but are not limited to, illite clays such as attapulgite, sepiolite, and allophone; smectite clays such as montmorillonite, bentonite, beidellite, nontronite, hectorite, saponite, and sauconite; kaolin clays such as kaolinite, dickite, nacrite, anauxite, and halloysite-endellite; and synthetic clays such as Laponite®, a synthetic aluminosilicate clay.

To form a nanocomposite, a clay (or a mixture of two or more different clays) may be dispersed in a liquid, generally water. The clay dispersion may generally include less than about 10 wt. % clay. For example, a clay dispersion may include from about 1 wt. % to about 5 wt. % clay, or from about 2 wt. % to about 4 wt. % clay, in another embodiment.

Following dispersion, the clay may be exfoliated to form nanoclay platelets. Sonication may be utilized to exfoliate the clay, according to standard practice. In general, sonication can be carried out for a period of time of greater than about 0.5 hours, for instance from about 1 hour to about 5 hours, so as to thoroughly exfoliate the clay. The method utilized to exfoliate the clay is not critical, however, and any method known in the art may be utilized. For instance, clay can be exfoliated through utilization of a high shear mixer. According to one such process, the clay dispersion can be mixed with a high shear mixer operating at greater than about 3000 RPM, or about 4000 RPM in one embodiment, for a period of a few minutes, e.g., from about 5 to about 10 minutes. However, any method that may form an aqueous dispersion of nanoclay may alternatively be utilized to exfoliate the clay.

Following exfoliation via, e.g., high shear mixing, a dispersion can include nanoclay platelets and few if any larger multilayer stacks. In general the nanoclay platelets may have a thickness of less than about 100 nanometers (nm), less than about 20 nm, less than about 10 nm, or less than about 5 nm as compared to multilayer stacks, which generally have a thickness on the micrometer scale, for instance greater than about 1 μm, or greater than about 5 μm.

The surface functionalized polyester can be combined with the clay dispersion, and the clay can adhere to the hydrophilic surface of the functionalized polyester in a relatively simple coating process. For instance, through utilization of a cationic polyelectrolyte, the positive charges on the polymer and the negative charges on the clay (e.g., montmorillonite) can interact through charge-charge interactions to adhere the clay to the polymer. Depending upon the nanoparticle, the pH of the solution may be adjusted to promote adhesion. For instance, certain cationic polyelectrolytes are more positively charged at low pH, and the solution may be adjusted accordingly to promote interaction between the polymer and the nanoparticles. Hydrogen bonding may also be promoted between the polymer and the nanoparticles

Inorganic species that may be applied to the surface functionalized polyester are not limited to clay nanoparticles, and other inorganic species such as metal nanoparticles may be adhered to a polyester substrate to form a value-added composite material. For example, metal nanoparticles such as gold or silver nanoparticles may be adhered to the surface of the treated polyester substrate.

A surface treated polyester substrate may be further processed to form a product. For instance rPET that has been surface treated to include clay nanoparticles at a surface may be melt processed according to standard practice to form a useful product, e.g., a packaging item. Due to the surface treatment process, the nanoparticles can be prevented from agglomerating during processing and may be well dispersed throughout the formed material, providing improved physical characteristics such as excellent barrier properties without loss of desired transparency.

The present disclosure may be better understood with reference to the Examples, below.

### Example 1

rPET that had been subjected to a partial saponification treatment was further treated with a polyelectrolyte to form a modified rPET followed by adherence of natural montmorillonite clay in the form of nanoparticles to the modified rPET.

Polyelectrolyte solutions were prepared in deionized water at a concentration of 1% (w/v). Polyelectrolytes examined included polyethylenimine (PEI) and poly(allylamine hydrochloride) (PAH). rPET flakes were soaked in a solution of polyelectrolyte at a concentration of 1 wt % in deionized water for 2 h, followed by an intense dionized water wash to remove loosely adsorbed polyelectrolyte chains. These polyelectrolyte-modified rPET flakes (e.g., rPET/PEI) were then exposed to a 1 wt % Na+ montmorillonite (MMT) suspension in deionized water for 1 h and washed as above. The resultant MMT-adsorbed rPET/polyelectrolyte flakes (rPET/PEI/MMT; rPET/PAH/MMT) were dried under vacuum at 70° C. As a control, rPET flakes were immersed in a 1 wt % Na+ MMT suspension for 1 h, followed by washing, to determine the extent of clay adsorption in the absence of the polyelectrolyte layer

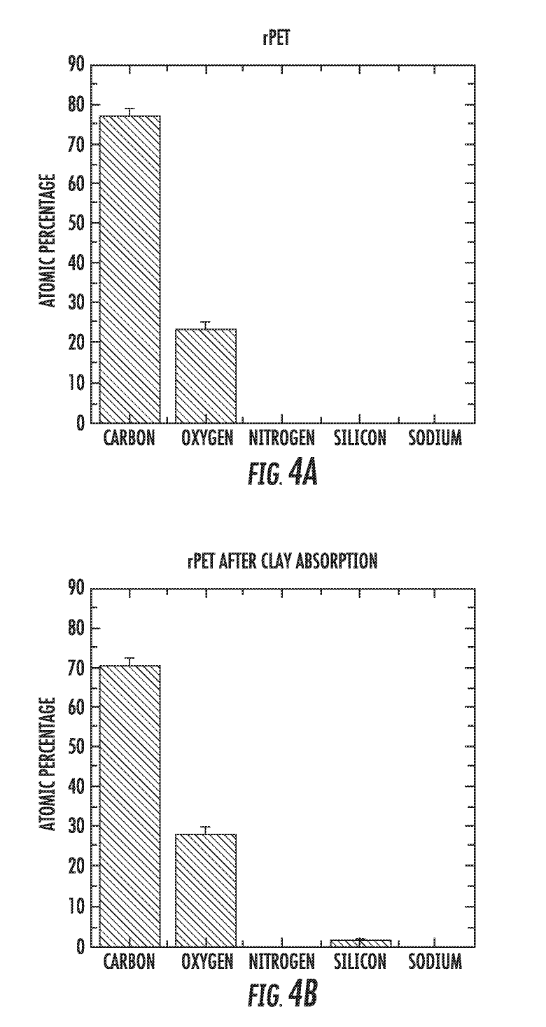

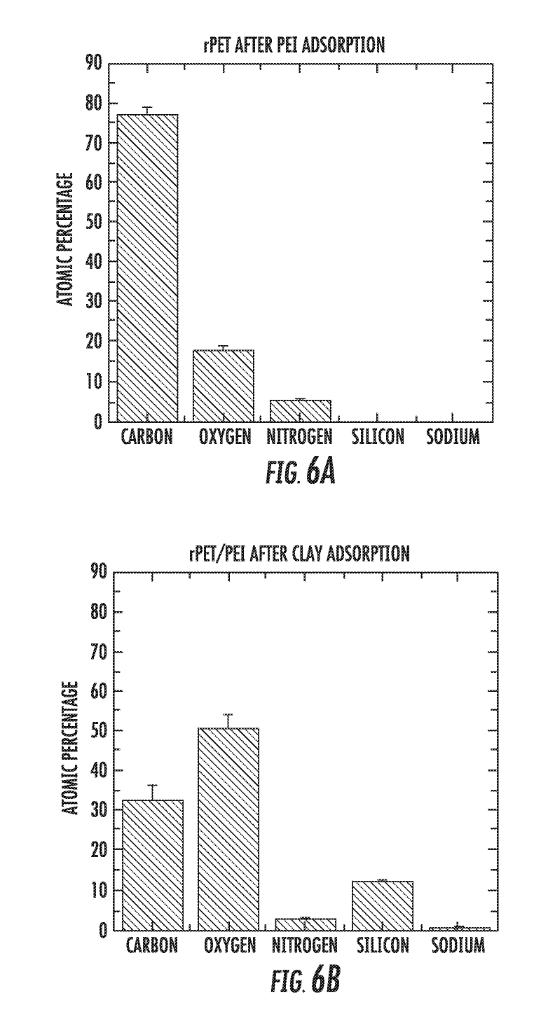

FIG. 4A illustrates the atomic percentage of the rPET prior to surface functionalization, and FIG. 4B illustrates the rPET following clay adsorption for the control. As can be seen, clay has adhered to the rPET as evidenced by the increased silicon content in the material, though the add-on level is quite small. In comparison, FIGS. 6A and 6B show the results of treating the rPET first with the polyelectrolyte polyethylenimine (PEI) followed by clay adsorption to the polyelectrolyte-treated surface. In FIG. 6A the addition of the PEI is evidenced by the increased nitrogen content of the material, and in FIG. 6B, the material has been modified to contain considerably more clay as compared to the material of FIG. 6A as is evidenced by the increased content of both silicon and sodium in the material.

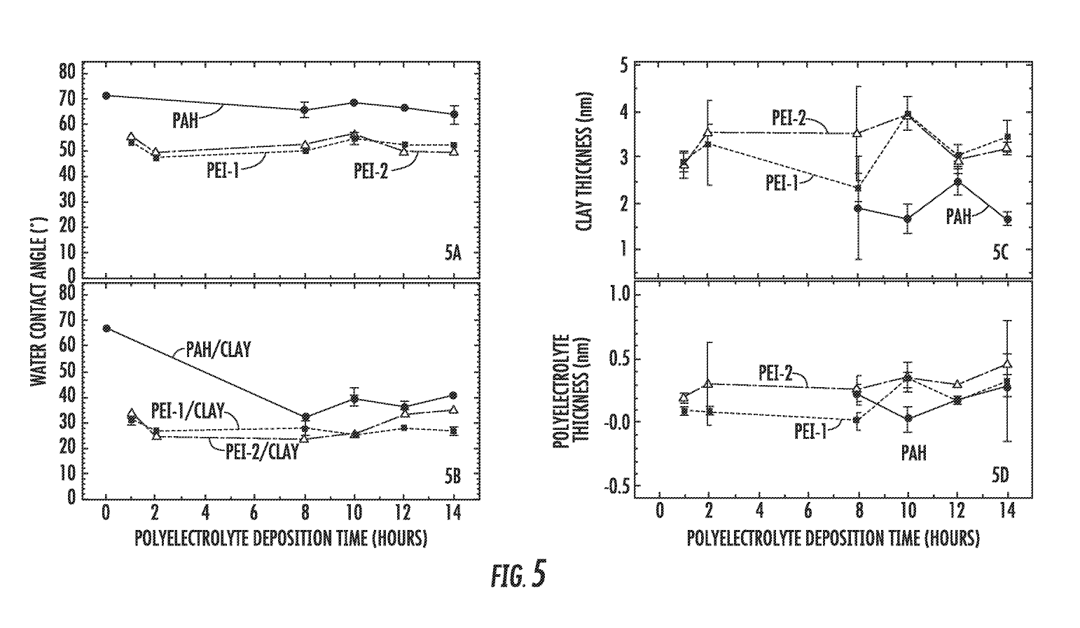

FIG. 5A-5D provide information with regard to the effect of the surface functionalization of the rPET on wettability. FIGS. 5A and 5B illustrate the water contact angle for the rPET chips following adsorption of the polyelectrolyte (FIG. 5A) (two samples with PEI and one with PAH) and subsequent adsorption of the clay nanoparticles to the polyelectrolyte (FIG. 58). FIGS. 5C and 5D provide thickness information with regard to the two layers that are applied to the rPET flakes. The increase in wettability and the small increase in thickness confirms the adsorption of the polyelectrolyte and the clay platelets to the substrate.

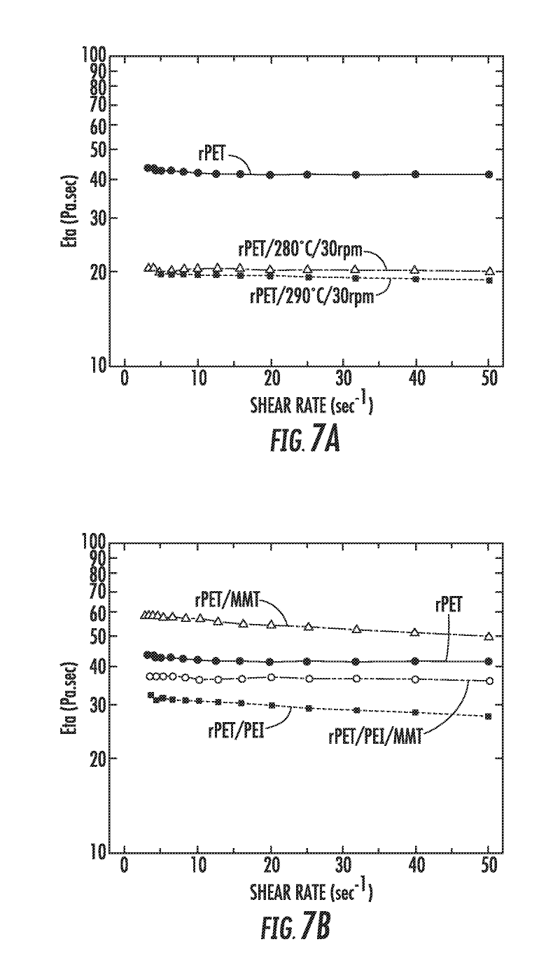

FIG. 7A illustrates the degradation of rPET during extrusion as evidenced from the viscosity data shown in the figure. In FIG. 7B can be seen an increase in the viscosity for the rPET clay sample due to the presence of the clay, which increases the rigidity of the polymer melt. Following extrusion, there is still some loss in viscosity (FIG. 7C), but it is less than that found for the unmodified rPET as illustrated in FIG. 7A.

### Example 2

The surfaces of electrospun PET microfibers were functionalized by growing thermoresponsive PNIPAAm brushes through a multi-step chemical sequence that avoids PET degradation. Amidation with deposited APTES, followed by hydrolysis yields silanol groups that permit surface attachment of initiator molecules, which can be used to grow PNIPAAm via ATRP. Spectroscopic analyses performed after each step confirmed the expected reaction and the ultimate growth of PNIPAAm brushes. Water contact angle measurements conducted at temperatures below and above the lower critical solution temperature of PNIPAAm, coupled with adsorption of Au nanoparticles from aqueous suspension, demonstrated that the brushes retain their reversible thermoresponsive nature, thereby making PNIPAAm-functionalized PET microfibers suitable for applications such as filtration media, tissue scaffolds, delivery vehicles, and sensors requiring mechanically robust microfibers.

Food-grade recycled PET flakes were supplied by the United Resource Recovery Corp. (Spartanburg, S.C.). The HFIP was obtained from Oakwood Products Inc. (Estill, S.C.), and anhydrous toluene, 2-chlorophenol, APTES, NIPAAm, copper I bromide (CuBr), and N,N,N,N,Nn-pentamethyldiethylenetriamine (PMDETA) were all purchased from Sigma-Aldrich and used as-received. Citrate-stabilized Au nanoparticles (diameter=16.9±1.8 nm) were synthesized as described in the literature (see, e.g., R. R. Bhat, J. Genzer, Appl. Surf. Sci. 2006, 252, 2549).

The PET flakes were dissolved in HELP at different concentrations and electrospun at ambient temperature and 10 kV to generate microfibers varying in diameter. Thin films of PET measuring 12 and 180 nm thick, as discerned by ellipsometry were spun-cast at 25° C. on silicon wafers from 0.5 and 3.0% (w/w) solutions, respectively, in 2-chlorophenol. Microfiber mats and thin films were stored under vacuum for at least 48 h prior to use to remove entrapped solvent.

APTES was deposited on the PET microfibers and thin films by exposing the samples to 1% (v/v) APTES/anhydrous toluene solutions for 24 h at ambient temperature, followed by sonication in toluene for 10 min to remove loosely adsorbed APTES molecules. The ethoxysilane groups of the surface-anchored APTES molecules were hydrolyzed in acidic water (pH 4.5-5.0). After drying the samples under reduced pressure, BMPUS was deposited on the PET-SiOH surfaces by established protocols. The PNIPAAm brushes were subsequently grown from PET-SiOH surfaces by ATRP of NIPAAm, as described elsewhere.

Specifically, 6.30 g NIPAAm was dissolved in a mixture of 4.86 g methanol and 6.30 g water in an argon-purged Schlenk flask, and oxygen was removed via three freeze-thaw cycles. After removal of oxygen, PMDETA (0.56 g) and CuBr (0.16 g) were added to the solution prior to an additional freeze-thaw cycle. The Schlenk flask was tightly sealed and transferred to an argon-purged glove box. Microfiber mats and thin films of PET were submersed in the solution for specific time intervals, after which they were removed, promptly rinsed with methanol and deionized water, and then sonicated in deionized water for 10 min.

The thickness of the thin PET films was measured by variable-angle spectroscopic ellipsometry (J. A. Woollam) at a 70° incidence angle before and after each modification step to discern the PNIPAAm brush height. Surface chemical composition was monitored by XPS performed on a Kratos Analytical AXIS ULTRA spectrometer at a take-off angle of 90°. The FTIR analysis of the PET microfibers was conducted in transmission mode on a Nicolet 6700 spectrometer after embedding the microfiber mats in potassium bromide pellets. For each sample, 1024 scans were acquired after background correction at a resolution of 4 cm⁻¹. Resultant XPS and FTIR spectra were analyzed using the CasaXPS and Omnic Spectra software suites, respectively. The thermoresponsive behavior of PET and PET-PNIPAAm microfibers was interrogated by measuring the WCA at different temperatures via the sessile drop technique on a Ramé-Hart Model 100-00 instrument. As-spun and modified PET microfibers were coated with about 8 nm of gold, and their diameter and surface morphology were examined by field-emission SEM performed on a JEOL 6400F electron microscope operated at 5 kV.

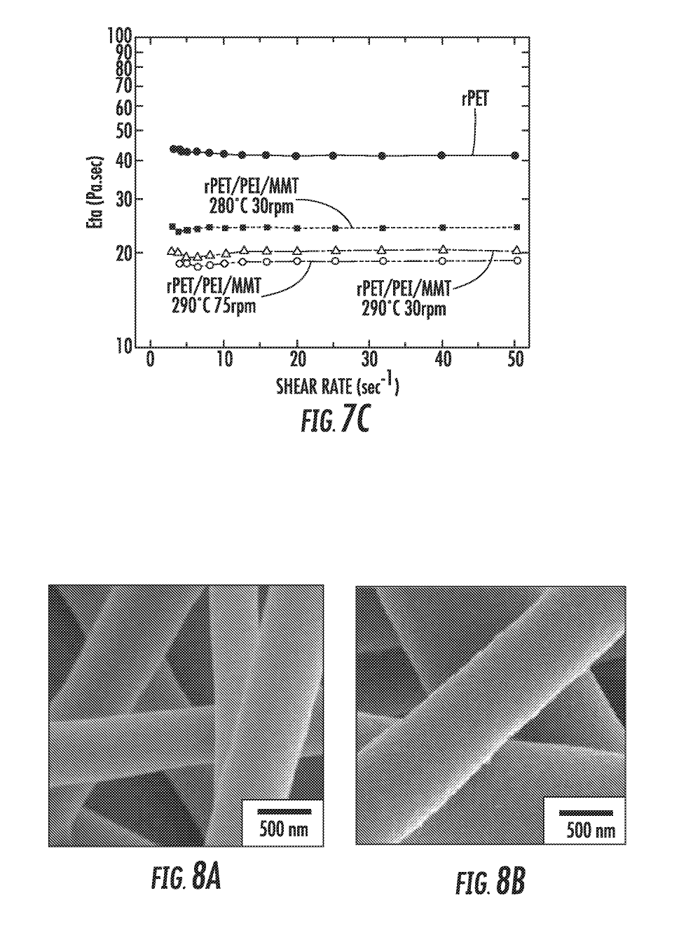

The diameters of electrospun PET microfibers, were measured by scanning electron microscopy (SEM) as 450, 800 and 1200 nm for 6, 8 and 10% (w/w) solutions, respectively, of PET in hexafluoroisopropanol (HFIP). The surfaces of unmodified PET microfibers consistently appear smooth with some slight dimpling occasionally observed along the fiber axis (FIG. 8A). Microfibers modified with thermoresponsive PNIPAAm brushes were generated in a sequence of four steps. Briefly, APTES molecules were attached to the PET surface via aminolysis between PET and the primary amine of APTES. Next, the ethoxysilane groups on APTES were hydrolyzed to generate silanol groups for BMPUS attachment. Finally, PNIPAAm brushes were grown directly from the PET microfiber surface. FIG. 8A displays the starting PET microfibers and FIG. 8B displays the PET microfibers modified with PNIPAAm brushes and demonstrates that these microfibers appear marginally rougher than the as-spun microfibers due to the presence of PNIPAAm brushes. The difference in microfiber morphology is almost indiscernible, verifying that the brush is uniformly distributed on the surface of the microfibers.

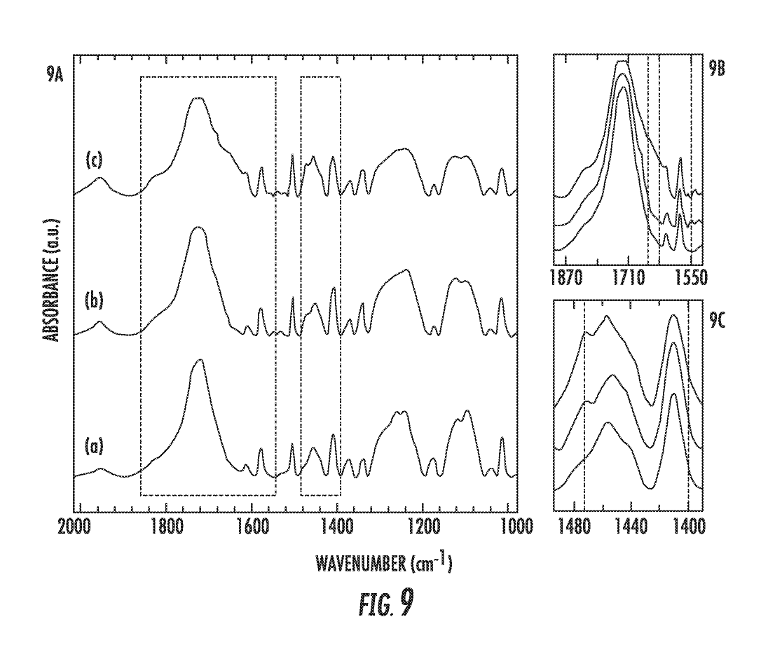

In FIG. 9 Fourier-transform infrared (FTIR) spectra are presented for three materials: (a) as-spun microfibers (PET), (b) APTES-modified microfibers following hydrolysis (PET-SiOH) and (c) microfibers with PNIPAAm brushes (PET-PNIPAAm). The appearance of new peaks located at 1650 cm⁻¹ (amide I band) 1550 cm⁻¹ (amide II band), 1470 cm⁻¹, and 3300 cm⁻¹ in FIG. 9 are due to the formation of secondary amide groups, thereby confirming the presence of amide groups on the PET-SiOH microfiber surface. Detection of these groups by FTIR is attributed to the large surface area afforded by the microfibers. Spectra arranged in the same order in the expanded views of FIG. 9B and FIG. 9C reveal the appearance of peaks associated with the formation of secondary amide moieties.

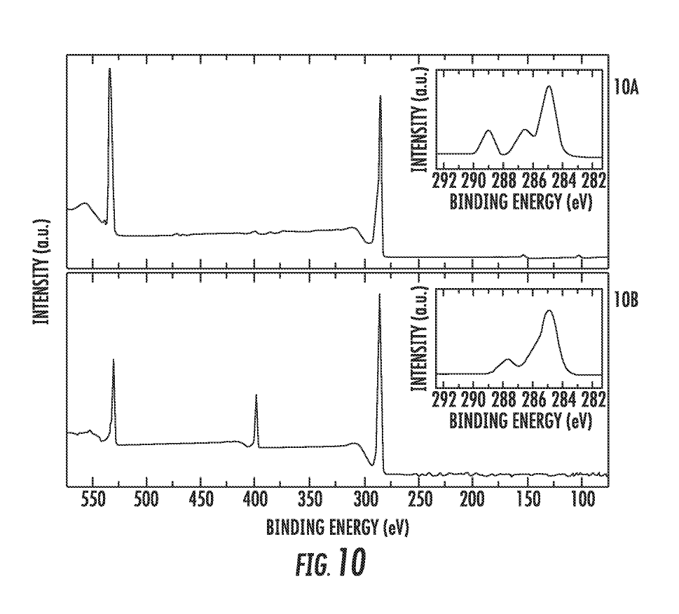

Attachment of APTES can also be inferred from the surface properties of modified microfibers upon exposure to acidic water, which promotes hydrolysis of the ethoxysilane groups to silanol groups. Resulting changes in water contact angle (WCA) and specimen thickness are measured on flat PET films spun-cast on silicon wafer. Values of WCA for films of PET-SiOH and PET after hydrolysis were 500.8° and 71±0.8°, respectively, whereas that for untreated PET was 75±0.2°. In addition, the X-ray photoelectron spectroscopy (XPS) measurements provided in FIG. 10A reveal the existence of a small N1, peak at 400 eV, which corresponds to 0.6 atom % N from hydrolyzed APTES on the PET-SiOH surface. In the next step, BMPUS molecules are attached to the PET-SiOH surface to serve as initiator centers for the “grafting from” polymerization of NIPAAm.

Subsequent growth of PNIPAAm brushes is established by the FTIR spectra presented in FIG. 9 at (c) and FIG. 10B, respectively. The characteristic secondary amide IR vibrations located at 1650 cm-1, 1550 cm-1, 1470 cm-1, and 3300 cm-1 are the most pronounced for PET/PNIPAAm microfibers. In addition, the appearance of a relatively intense N1, peak at 400 eV in FIG. 10B indicates an elevated concentration of N, which is consistent with the presence of PNIPAAm brushes. Quantification of this spectrum yields the atomic concentrations as shown in Table 1, below.

TABLE 1

| | | | NIPAAm | |
|---|---|---|---|---|
| | | Theoretical | grafted PET | Theoretical |
| | PET Fiber | PET | Fiber | Fiber |
| Carbon | 73.2 ± 0.5% | 71.4% | 76.8 ± 0.4% | 75.0% |
| Oxygen | 26.8 ± 0.4% | 28.6% | 11.6 ± 0.5% | 12.5% |
| Nitrogen | 0% | 0 | 11.6 ± 0.3% | 12.5% |

These values agree favorably with theoretical concentrations obtained from the chemical structure of PNIPAAm, as shown in Table 1. The high-resolution C1s spectra included in the insets of FIG. 10 likewise demonstrate that the PNIPAAm brushes cover the PET surface. In FIG. 10A, the spectrum displays peaks at 289.0 and 286.6 eV corresponding to 0-C=0 and C-0 functionalities, respectively. These signature peaks for PET disappear upon growth of the PNIPAAm brushes, which are responsible for a new peak at 287.8 eV (N—C=0 groups) and a shoulder at 286.1 eV (C—N bonds). Since the XPS fingerprint for PET is lost upon PNIPAAm brush growth, it can be inferred that the thickness of the dry brushes is at least the probe depth of XPS (about 10 nm).

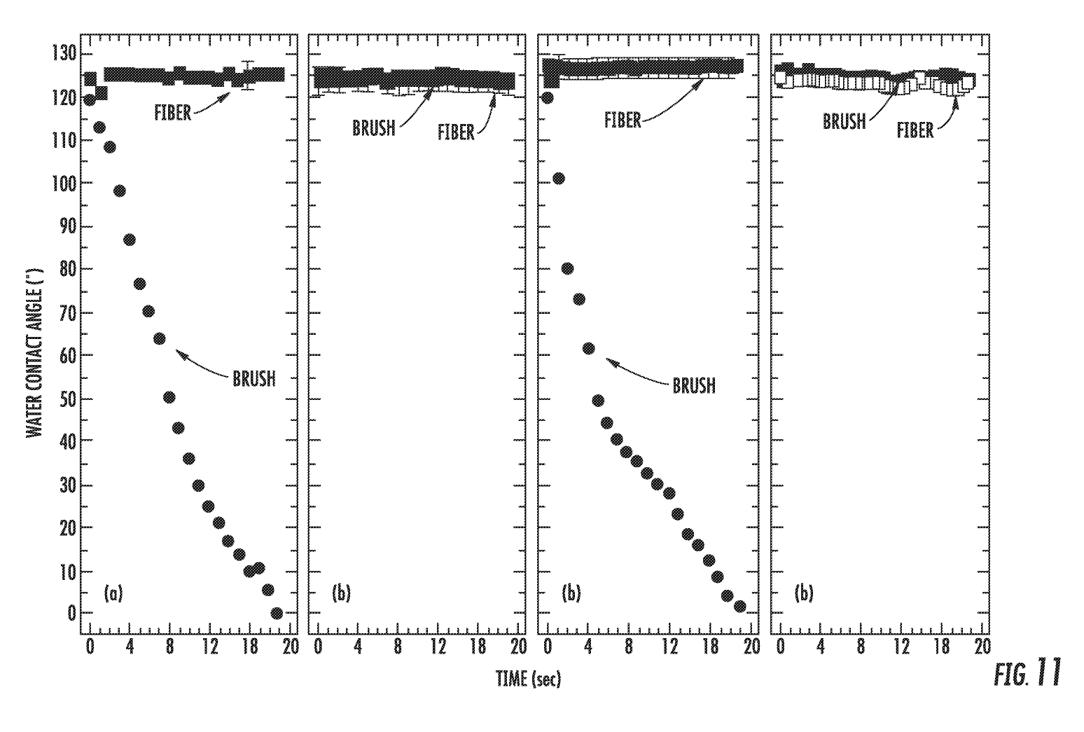

The thermoresponsiveness of the PNIPAAm brushes grown on PET microfibers was evaluated with WCA experiments performed successively above and below the T_{c} of PNIPAAm, as shown in FIG. 11. The WCA of unmodified PET microfibers at 25° C. (FIG. 11(a)) is about 125°, which is higher than that of a flat PET film (75°) because of the “rough” nature of the microfiber mat. Despite this increase in surface roughness, the size of the water droplet on the surface of unmodified PET microfibers does not change during the course of the measurement, and the measured WCA remains constant. In FIG. 11(b), the WCA of the unmodified PET microfibers at 60° C. is 124° and likewise does not change, which suggests that water evaporation is negligible, Cycling the specimen between these two temperatures yields comparable results as shown in FIGS. 11(c) and 11(d), confirming that the PET surface stays hydrophobic.

In comparison, measured WCA values of PET-PNIPAAm microfibers display significantly different behavior. At 25° C. (FIG. 11(a)), the WCA is also about 125° when the water droplet is initially placed on the microfiber surface, but quickly decreases to 0° in just over 40 seconds as the water is wicked by the hydrophilic PNIPAAm brushes on the surface of the microfibers. When the temperature is increased beyond T_{c} of PNIPAAm to 60° C. (FIG. 11(b)), the water droplet is not strongly affected by the microfiber due to the increased hydrophobicity of the PNIPAAm chains, and the WCA remains at about 124°. Repetition of these measurements upon thermal cycling in FIGS. 11(c) and 11(d) confirm that the thermoresponsiveness of PNIPAAm brushes on PET microfibers is reversible with no evidence of hysteresis.

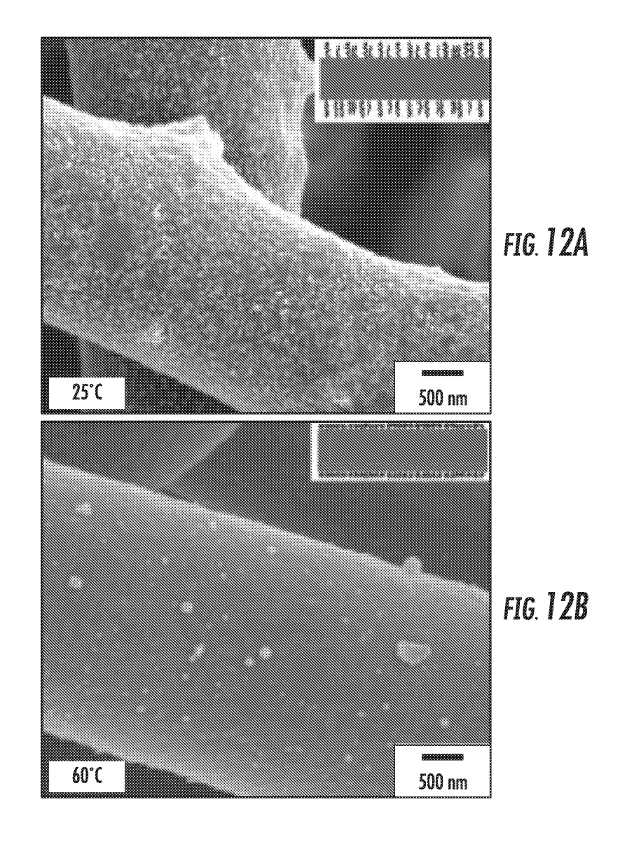

A second probe of the thermoresponsive nature of PNIPAAm brushes on PET microfibers employed gold nanoparticles as tracers. Previous studies have established that gold nanoparticles attach to PNIPAAm chains via hydrogen bonding between the citrate groups present on the nanoparticle surface and the amide groups on PNIPAAm. To discern the extent to which the PNIPAAm brushes could bind gold nanoparticles, electrospun PET microfibers were submerged in a 0.1% (w/w) suspension of gold nanoparticles in deionized water for 24 h at the same two temperatures examined in FIG. 11, i.e., 25° C. and 60° C. Images acquired by SEM reveal that the nanoparticle loading on the surface of PET-PNIPAAm microfibers is significantly higher at 25° C. (FIG. 12A) than at 60° C. (FIG. 12B). This difference is attributed to the thermoresponsiveness of the PNIPAAm chains, which are hydrophilic and swell in water at temperatures below T, but become hydrophobic and collapse in water at temperatures above T. As a result of such swelling or contracting, the concentration of bound gold nanoparticles depends on temperature relative to T_{c} of PNIPAAm. Subsequent exposure of PET-PNIPAAm microfibers containing gold nanoparticles loaded at 25° C. to deionized water at 60° C. results in nanoparticle discharge due to PNIPAAm chain collapse. This observation confirms that these surface brushes can be loaded with an auxiliary species at low temperatures (relative to T_{c}) and then used to deliver a payload at temperatures above T_{c}. The same principle can be further exploited to use the brushes to remove a contaminant (by, e.g., filtration) and then clean and re-use the brush by thermal cycling.

While the subject matter has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present disclosure should be assessed as that of the appended claims and any equivalents thereto.

What is claimed is:

1. A method for recycling polyester comprising:
forming a slurry comprising polyester and an alkaline compound;
saponifying only a portion of the polyester according to a saponification reaction between the polyester and the alkaline compound;
forming a polymeric layer on the surface of the polyester that remains following the saponification reaction, wherein the formation of the polymeric layer increases the hydrophilicity of the polyester surface.

2. The method according to claim 1, wherein the polyester is polyethylene terephthalate.

3. The method according to claim 1, wherein the polymeric layer comprises a polyelectrolyte having a net positive charge.

4. The method according to claim 3, where in the step of forming the polymeric layer on the surface of the polyester comprises an aqueous deposition process.

5. The method according to claim 4, wherein the aqueous deposition process is a dip coating process.

6. The method according to claim 1, wherein the step of forming the polymeric layer on the surface of the polyester comprises polymerizing a monomer at the surface to form a polymer brush.

7. The method according to claim 1, further comprising adhering an inorganic species to the polymeric layer.

8. The method according to claim 7, wherein the inorganic species comprises a natural clay.

9. The method according to claim 7, wherein the inorganic species comprises a metal.

10. The method according to claim 7, further comprising melt processing the polyester comprising the polymeric layer and the inorganic species to form a polymeric nanocomposite.

11. A method for functionalizing the surface of a polyester substrate, the method comprising:
bonding an amino silane coupling agent to the surface of the polyester substrate, the amino silane coupling agent comprising silane groups;
hydrolyzing the silane groups of the coupling agent to form silanol groups;
bonding a polymerization initiator to the substrate via a reaction between the initiator and the silanol groups;
polymerizing a monomer at the substrate surface according to a polymerization process to form a polymer brush at the surface of the polyester substrate.

12. The method according to claim 11, wherein the polymerization initiator is an atom transfer radical polymerization initiator.

13. The method according to claim 11, further comprising adhering an inorganic species to the polymer brush.

14. The method according to claim 13, wherein the inorganic species comprises a natural clay.

15. The method according to claim 13, wherein the inorganic species comprises a metal.

16. The method according to claim 13, further comprising further processing the polyester comprising the polymer brush.

17. The method according to claim 11, further comprising melt processing or solution processing a polyester to form the polyester substrate.

18. The method according to claim 17, wherein the polyester that is melt or solution processed is a recycled polyester.

19. The method according to claim 17, wherein the solution processing comprises electrospinning the polyester.

20. The method according to claim 11, wherein the polymer of the polymer brush exhibits a response to an environmental stimulus.

21. The method according to claim 20, wherein the polymer is thermoresponsive.
